(19) United States
(12) Patent Application Publication
(10) Pub. No.: US 2020/0337809 A1
(43) Pub. Date: Oct. 29, 2020

(54) MODIFIED MAXILLARY SKELETAL RAPID EXPANDER DEVICE AND METHOD

(71) Applicant: Paul Kim, Norwalk, CA (US)

(72) Inventor: Paul Kim, Norwalk, CA (US)

(21) Appl. No.: 16/851,851

(22) Filed: Apr. 17, 2020

Related U.S. Application Data
(63) Continuation-in-part of application No. 16/556,432, filed on Aug. 30, 2019.
Application No. 16/556,432 is a continuation-in-part of application No. 16/394,846, filed on Apr. 25, 2019.

(51) Int. Cl. A61C 7/10

(52) U.S. Cl. CPC A61C 7/10

(57) ABSTRACT

The present invention discloses a rapid palatal expander (“RPE”) device that provides for enhanced effectiveness of maxillary skeletal expansion. Also disclosed are methods of making and using the RPE device.

### CROSS-REFERENCE TO RELATED APPLICATIONS

This application is a continuation-in-part of U.S. application Ser. No. 16/556,432, filed Aug. 30, 2019, which, in turn, is a continuation-in-part of U.S. application Ser. No. 16/394,846, filed Apr. 25, 2019. The teachings of these prior applications are incorporated herein by reference in their entirety.

### FIELD OF THE INVENTION

The present invention generally relates an orthodontic device and more specifically a device for expanding upper jaw of a patient, and more particularly to maxillary skeletal expanders.

### BACKGROUND OF THE INVENTION

Traditionally, orthodontists have used a Rapid Palatal Expander (“RPE”) attached to an orthodontic appliance to force an expansion between the plates in the palatal bone. The RPE is the “engine” behind the appliance, and is engaged by turning a gear mechanism that exerts outward force onto the palatal bone and surrounding teeth, thereby causing an expansion between the two plates of the palatal bone.

There are a number of shortcomings in the existing RPE devices. For example, these devices are relatively bulky and require guide rails are round-shaped and subject to side wiggling movement caused by side push caused by biting stress so as to compromise efficacy of treatment.

Therefore, it is an object of the present invention to provide a more effective RPE device.

It is a further object of the present invention to provide an RPE device having a design configured for being a device of a reduced dimension.

The embodiments below address the above described issues, needs, and/or objects.

### SUMMARY OF THE INVENTION

In one aspect of the present invention, it is a modified rapid palatal expander (“RPE”) device, comprising:

two halves of a device body, each half having a left side and a right side, and a middle portion;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

In some embodiments of the invention device, optionally in combination with any of the various embodiments herein, each half of the device body comprises two anchoring legs configured to be fixed directly to a palatine bone, with one anchoring leg affixed or releasably attached to its right side and the other affixed or releasably attached to its left side.

In some embodiments of the invention device, optionally in combination with any of the various embodiments herein, wherein the two halves of the device body, the two arms, the lock screw, and the pair of guide rails have an antimicrobial surface.

In some embodiments of the invention device, optionally in combination with any of the various embodiments herein, the device comprises four arms, each of the two halves of the device body having two arms attached thereto, one to its left side and the other to its right side.

The RPE device of claim 5, further comprising:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments of the invention device, optionally in combination with any of the various embodiments herein, wherein the lock screw is configured to allow the use of a screw driver or a wrench for adjusting the distance between the two halves of the device body.

In some embodiments of the invention device, optionally in combination with any of the various embodiments herein, wherein the guide rails are of an angled shape.

In some embodiments of the invention device, optionally in combination with any of the various embodiments herein, wherein the guide rails are of a rectangular shape.

In another aspect of the present invention, it is provided a method of fabricating a modified rapid palatal expander (“RPE”) device, comprising:

providing a design of the device, and forming the device, the RPE device comprising:

two halves of a device body, each half having a left side and a right side, and a middle portion;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

In some embodiments of the invention method, optionally in combination with any of the various embodiments herein, wherein each half of the device body comprises two anchoring legs configured to be fixed directly to a palatine bone, with one anchoring leg affixed or releasably attached to its right side and the other affixed or releasably attached to its left side.

In some embodiments of the invention method, optionally in combination with any of the various embodiments herein, wherein the two halves of the device body, the two arms, the lock screw, and the pair of guide rails have an antimicrobial surface.

In some embodiments of the invention method, optionally in combination with any of the various embodiments herein, wherein the RPE device comprises four arms, each of the two halves of the device body having two arms attached thereto, one to its left side and the other to its right side.

In some embodiments of the invention method, optionally in combination with any of the various embodiments herein, wherein the RPE device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments of the invention method, optionally in combination with any of the various embodiments herein, wherein the lock screw is configured to allow the use of a screw driver or a wrench for adjusting the distance between the two halves of the device body.

In some embodiments of the invention method, optionally in combination with any of the various embodiments herein, wherein the guide rails are of an angled shape.

In some embodiments of the invention method, optionally in combination with any of the various embodiments herein, wherein the guide rails are of a rectangular shape.

In a further aspect of the present invention, it is provided a method of treating a maxillary skeletal disorder, comprising:

detecting a maxillary skeletal disorder in a patient;

prescribing a RPE device to correct the maxillary skeletal disorder in the patient; and

applying the RPE device to the patient; and periodically adjusting the RPE device by turning a lock screw on the device until a desired result of maxillary skeletal expansion is achieved, the RPE comprising:

two halves of a device body, each half having a left side and a right side, and a middle portion;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

In some embodiments of the invention method, optionally in combination with any of the various embodiments herein, wherein each half of the device body comprises two anchoring legs configured to be fixed directly to a palatine bone, with one anchoring leg affixed or releasably attached to its right side and the other affixed or releasably attached to its left side.

In some embodiments of the invention method, optionally in combination with any of the various embodiments herein, wherein the two halves of the device body, the two arms, the lock screw, and the pair of guide rails have an antimicrobial surface.

In some embodiments of the invention method, optionally in combination with any of the various embodiments herein, wherein the RPE device comprises four arms, each of the two halves of the device body having two arms attached thereto, one to its left side and the other to its right side.

In some embodiments of the invention method, optionally in combination with any of the various embodiments herein, wherein the RPE device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments of the invention method, optionally in combination with any of the various embodiments herein, wherein the lock screw is configured to allow the use of a screw driver or a wrench for adjusting the distance between the two halves of the device body.

In some embodiments of the invention method, optionally in combination with any of the various embodiments herein, wherein the guide rails are of an angled shape.

In some embodiments of the invention method, optionally in combination with any of the various embodiments herein, wherein the guide rails are of a rectangular shape.

### BRIEF DESCRIPTION OF THE DRAWINGS

FIG. 1 shows a front few of a triangular arrangement of a lock screw and two guide rails in relation to each other in an embodiment device of invention.

FIG. 2 is a front view showing an opening for a lock screw, two openings for two guide rails placed underneath the lock screw opening, and two openings for two arms of an embodiment of the invention device.

FIG. 3A and FIG. 3B show front views of one of the two halves 100 of embodiments of the invention device.

FIG. 4 shows a two guide rails and a lock screw of an embodiment of the invention device.

FIG. 5 shows a side view of one of the two halves of an embodiment of invention device

FIG. 6 shows an embodiment of invention device having an anti-microbial surface.

FIG. 7 shows an embodiment of invention device having a tooth-fixing part.

### DETAILED DESCRIPTION OF THE INVENTION

The present invention overcomes shortcomings of the existing rapid palatal expander devices mentioned above. In one aspect of the present invention, it is a modified rapid palatal expander (“RPE”) device, comprising:

two halves of a device body, each half having a left side and a right side, and a middle portion;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

In some embodiments of the invention device, optionally in combination with any of the various embodiments herein, each half of the device body comprises two anchoring legs configured to be fixed directly to a palatine bone, with one anchoring leg affixed or releasably attached to its right side and the other affixed or releasably attached to its left side.

In some embodiments of the invention device, optionally in combination with any of the various embodiments herein, wherein the two halves of the device body, the two arms, the lock screw, and the pair of guide rails have an antimicrobial surface.

In some embodiments of the invention device, optionally in combination with any of the various embodiments herein, the device comprises four arms, each of the two halves of the device body having two arms attached thereto, one to its left side and the other to its right side.

In some embodiments of the invention device, optionally in combination with any of the various embodiments herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments of the invention device, optionally in combination with any of the various embodiments herein, wherein the lock screw is configured to allow the use of a screw driver or a wrench for adjusting the distance between the two halves of the device body.

In some embodiments of the invention device, optionally in combination with any of the various embodiments herein, wherein the guide rails are of an angled shape.

In some embodiments of the invention device, optionally in combination with any of the various embodiments herein, wherein the guide rails are of a rectangular shape.

As used herein, the term “top surface” of an anchoring leg refers to the surface of the anchoring leg contacting the palatal surface of the oral cavity.

As used herein, the term “direction of expansion” or “expansion direction” are used interchangeably and refers to the direction of an expansion force of the expander device toward the buccal sides generated by turning of the lock screw of the invention device. As is guided by the guide rails, the direction of expansion of the invention device must be in the body plane of the expander device and in the direction of the guide rails.

As used herein, the term “angled” refers to a shape of guide rail of the invention device that is not round-shaped, where at least two adjacent sides of a guide rail form an angle. In this context, in one embodiment, the term “angled shape” has a cross-section of rectangular, and a guide rail with such a cross-section shape is a triangular prism.

In some embodiments of the invention method, optionally in combination with any of the various embodiments disclosed herein, a metallic or non-metallic material (e.g., a biocompatible polymeric material) can be used to form any or all parts of the device.

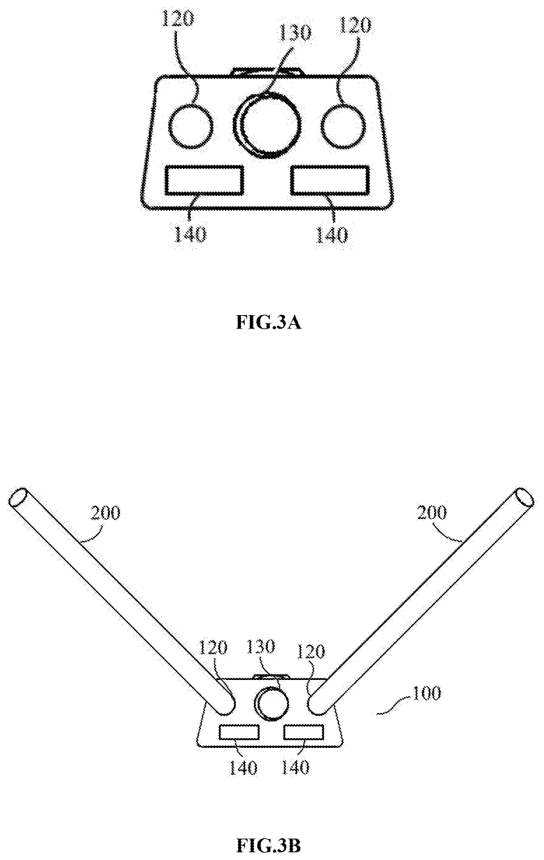

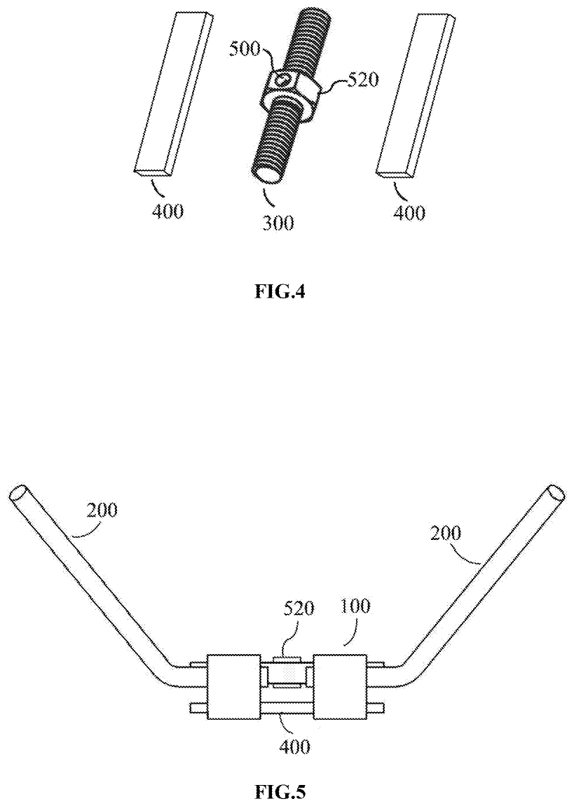

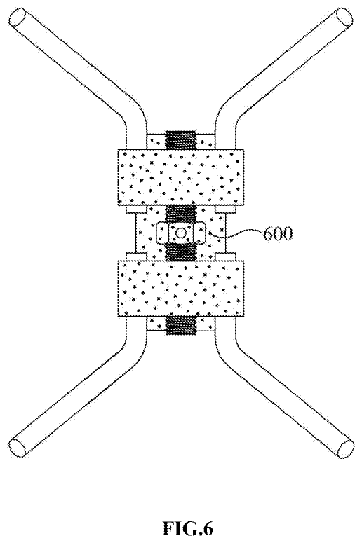

Representative embodiments of the disclosed device are shown in the FIG. 1-7. FIG. 3B shows that one half of the device body, 100, includes two arms 200 being connected to the one half device 100 through connection points 120, an opening 130 to receive lock screw 300, and two rectangular openings 140 underneath opening 130 to receive two rectangular guide rails 400, opening 130 and openings 140 being configured in such a way that center points of opening 130 and openings 140 form a triangular relationship. The lock screw 300 and guide rails 400 are shown in FIG. 4. Again in FIG. 4, the lock screw 300 is shown to have a key hole 500 for turning the lock screw 300, the key hole 500 being configured to accommodate a nut 520 such that a wrench can be used to turn the lock screw 300.

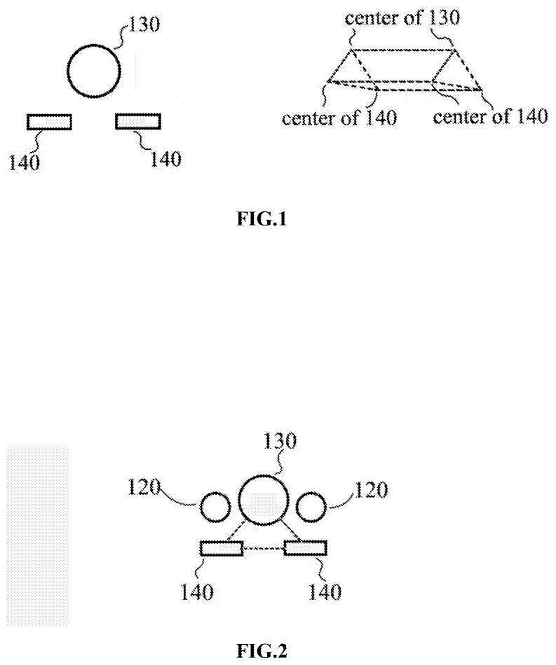

FIG. 1 and FIG. 2 are front cross-sectional views of one half of the device body, 100, which clearly show the triangular relationship between the opening 130 and the openings 140, the center points of which forming a triangle (shown in dash line) and the triangles on each one half of device body, 100, forming a triangular prism where the parallel dash lines indicate one center line of the lock screw 300 and two center lines of the guide rails. A person of ordinary skill in the art would recognize that the dash lines are perceived, which is used here solely to show the configurational relationship of the elements of an embodiment of the disclosed device.

FIG. 3A shows the front view of one half of device body, 100, of an embodiment of the present invention. In this embodiment, the device includes

In FIG. 1, a front, cross-section view of an embodiment of the invention RPE device is shown, with the palatal bone contact side at the bottom and the tongue contact side at the top. The device has two halves 100, four arms 200, a lock screw 300 built with a turning key hole 500, and two guide rails 400.

An expanded view of an embodiment of the lock screw 300 and guide rails 400 is shown in FIG. 2, where the lock screw is shown to include a nut 520 on which the turning key hole 500 is built. In some embodiments, the nut 520 can be configured to allow the lock screw 300 to be turned using a wrench. Guide rails 400 are shown to include a notch 410 to accommodate nut 520 on lock screw 300.

FIG. 3A shows a side view of one of the two halves 100 of an embodiment of the invention device, showing two arms 200, attachment point or insertion point 120 for arm 200, lock screw hole 130 to receive one end of the lock screw 300, and a pair of holes 140 to receive guide rails 400.

FIG. 5 shows a side view of one of the two halves of an embodiment of invention device, showing one halve of the device body 100, two arms 200, a nut 520 on lock screw 300 (not shown), and a guide rail 400.

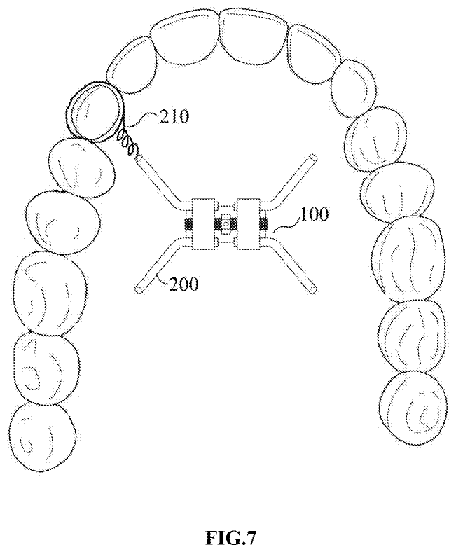

FIG. 7 shows an embodiment of the invention RPE device, viewed from the tongue facing surface, the RPE including a tooth fixing part 210 secured to a tooth, the tooth fixing part also being secured to an arm 200, which is attached to one half of the invention device body, 100, the one half having two arms 200. For concise description, labeling of other elements is omitted.

Antimicrobial Surface

In some embodiments, surface of the invention device can be modified to include an antimicrobial surface. Method of generating an antimicrobial surface on a metallic device is known in the art, which can be, for example, forming an antimicrobial coating on the device. The antimicrobial coating can include an antimicrobial agent, with or without a polymer. The antimicrobial agent can be an antimicrobial drug. In some embodiments, the antimicrobial agent can be silver nanoparticles. FIG. 7 depicts such antimicrobial surface on a device of invention where an antimicrobial surface 600 is formed onto the entire surface of the invention device, viewed from surface facing the palatal bone. Note, alternatively, the antimicrobial surface can cover only a portion of the surface of the invention device. For concise description, labeling of other elements is omitted.

### Methods of Fabrication

In another aspect of the present invention, it is provided a method of fabricating a modified rapid palatal expander (“RPE”) device, comprising:

providing a design of the device, and

forming the device, the RPE device comprising:

two halves of a device body, each half having a left side and a right side, and a middle portion;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

In some embodiments of the invention method, optionally in combination with any of the various embodiments herein, wherein each half of the device body comprises two anchoring legs configured to be fixed directly to a palatine bone, with one anchoring leg affixed or releasably attached to its right side and the other affixed or releasably attached to its left side.

In some embodiments of the invention method, optionally in combination with any of the various embodiments herein, wherein the two halves of the device body, the two arms, the lock screw, and the pair of guide rails have an antimicrobial surface.

In some embodiments of the invention method, optionally in combination with any of the various embodiments herein, wherein the RPE device comprises four arms, each of the two halves of the device body having two arms attached thereto, one to its left side and the other to its right side.

In some embodiments of the invention method, optionally in combination with any of the various embodiments herein, wherein the RPE device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments of the invention method, optionally in combination with any of the various embodiments herein, wherein the lock screw is configured to allow the use of a screw driver or a wrench for adjusting the distance between the two halves of the device body.

In some embodiments of the invention method, optionally in combination with any of the various embodiments herein, wherein the guide rails are of an angled shape.

In some embodiments of the invention method, optionally in combination with any of the various embodiments herein, wherein the guide rails are of a rectangular shape.

In some embodiments of the invention method, optionally in combination with any of the various embodiments disclosed herein, a metallic or non-metallic material (e.g., a biocompatible polymeric material) can be used to form any or all parts of the device.

The maxillary skeletal expander device of invention can be made from any biocompatible material having suitable mechanical strength as a maxillary skeletal expander device. Such material can be a metallic material or non-metallic material or both. Such biocompatible materials are well documented in the biomedical field, which include, for example, metallic materials such as titanium, zirconium, stainless steel, nitinol, aluminum, iron, or an alloy thereof, or in some embodiments, a polymeric material such as polylacic acid or high density polyethylene.

The anchoring leg can be attached to the RPE body of the maxillary skeletal expander device invention via any established method of attaching or joining a metallic part to another metallic body. Examples of such methods can be, but is not limited to, soldering, welding, or casting of buttons or any other attachment to the RPE.

### Method of Use

In a further aspect of the present invention, it is provided a method of treating a maxillary skeletal disorder, comprising:

detecting a maxillary skeletal disorder in a patient;

prescribing a RPE device to correct the maxillary skeletal disorder in the patient; and

applying the RPE device to the patient; and periodically adjusting the RPE device by turning a lock screw on the device until a desired result of maxillary skeletal expansion is achieved, the RPE comprising:

two halves of a device body, each half having a left side and a right side, and a middle portion;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

In some embodiments of the invention method, optionally in combination with any of the various embodiments herein, wherein each half of the device body comprises two anchoring legs configured to be fixed directly to a palatine bone, with one anchoring leg affixed or releasably attached to its right side and the other affixed or releasably attached to its left side.

In some embodiments of the invention method, optionally in combination with any of the various embodiments herein, wherein the two halves of the device body, the two arms, the lock screw, and the pair of guide rails have an antimicrobial surface.

In some embodiments of the invention method, optionally in combination with any of the various embodiments herein, wherein the RPE device comprises four arms, each of the two halves of the device body having two arms attached thereto, one to its left side and the other to its right side.

In some embodiments of the invention method, optionally in combination with any of the various embodiments herein, wherein the RPE device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments of the invention method, optionally in combination with any of the various embodiments herein, wherein the lock screw is configured to allow the use of a screw driver or a wrench for adjusting the distance between the two halves of the device body.

In some embodiments of the invention method, optionally in combination with any of the various embodiments herein, wherein the guide rails are of an angled shape.

In some embodiments of the invention method, optionally in combination with any of the various embodiments herein, wherein the guide rails are of a rectangular shape.

Those skilled in the art will know, or be able to ascertain, using no more than routine experimentation, many equivalents to the specific embodiments of the invention described herein. These and all other equivalents are intended to be encompassed by the following claims.

I claim:

1. A modified rapid palatal expander (“RPE”) device, comprising:
two halves of a device body, each half having a left side and a right side, and a middle portion;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body; and
a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

2. The RPE device according to claim 1, comprising four arms, each of the two halves of the device body having two arms attached thereto, one to its left side and the other to its right side.

3. The RPE device of claim 2, further comprising:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

4. The RPE device according to claim 1, wherein the lock screw is configured to allow the use of a screw driver or a wrench for adjusting the distance between the two halves of the device body.

5. The RPE device according to claim 1, wherein the guide rails are of an angled shape.

6. The RPE device according to claim 1, wherein the guide rails are of a rectangular shape.

7. The RPE device of claim 1, wherein the two halves of the device body, the two arms, the lock screw, and the pair of guide rails have an antimicrobial surface.

8. A method of fabricating a modified rapid palatal expander (“RPE”) device, comprising:
providing a design of the device, and
forming the device, the RPE device comprising:
two halves of a device body, each half having a left side and a right side, and a middle portion;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body; and
a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.

9. The method according to claim 8, wherein the RPE device comprises four arms, each of the two halves of the device body having two arms attached thereto, one to its left side and the other to its right side.

10. The method according to claim 8, wherein the RPE device further comprises:
a pair of teeth fixing parts, the distal end of each arm attached to one halve of the device body being secured to one of the pair of teeth fixing parts, and the distal end of each arm

11. The method according to claim 8, wherein the lock screw is configured to allow the use of a screw driver or a wrench for adjusting the distance between the two halves of the device body.

12. The method according to claim 8, wherein the two halves of the device body, the two arms, the lock screw, and the pair of guide rails have an antimicrobial surface.

13. The method according to claim 8, wherein the guide rails are of an angled shape.

14. The method according to claim 8, wherein the guide rails are of a rectangular shape.

15. A method of treating a maxillary skeletal disorder, comprising:
detecting a maxillary skeletal disorder in a patient;
prescribing a RPE device to correct the maxillary skeletal disorder in the patient; and
applying the RPE device to the patient; and periodically adjusting the RPE device by turning a lock screw on the device until a desired result of maxillary skeletal expansion is achieved, the RPE comprising:
two halves of a device body, each half having a left side and a right side, and a middle portion;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body; and
a pair of guide rails for guiding a movement of the two halves of the device body, the pair of guide rails each having a same and angled shape and being configured to be placed on each side underneath the lock screw such that the centerline of each slide rail and that of the lock screw are parallel to each other and form a triangular prism, with one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body.
